(19) United States
(12) Patent Application Publication
(10) Pub. No.: US 2005/0188093 A1
(43) Pub. Date: Aug. 25, 2005

(54) Apparatus and related methods for establishing a network connection

(76) Inventor: Wassim Haddad, Verdun Municipality (CA)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/697,961

(22) Filed: Oct. 31, 2003

(30) Foreign Application Priority Data
Apr. 5, 2003 (GB) 0307925.8

(51) Int. Cl. G06F 15/16

(52) U.S. Cl. 709/228; 709/229

(57) ABSTRACT

A method of establishing a network connection, capable of transmitting data, from a computing device, having a network connection with an existing network, to a network. The method comprises: determining whether data requested by the computing device originates within the network. If said data requested by the computing device does originate within the network, breaking at least a portion of the network connection with the existing network for the data and establishing a network connection with the network for that portion of the network connection that was previously connected to the existing network.

### FIELD OF THE INVENTION

This invention relates to a method and related apparatus of and for establishing a network connection.

### BACKGROUND OF THE INVENTION

Wireless networks, such as the WIFI (IEEE 802.11), are becoming increasingly popular. Each such wireless network is provided by one or more hubs, sometimes referred to as mobility agents, which transmit and receive data from computing devices, generally referred to as mobile nodes. Each mobility agent has a finite range and thus, if a mobile node moves beyond this range, communication between the mobility agent and the mobile node will be lost.

However, it is possible for a mobile node to become disconnected from a network whilst having the possibility of being connected to a further network. The disconnection from the existing network is generally in a wireless network by the mobile node moving beyond the communication range of a mobility agent with which it is connected in that network. However, the existing network could also be disconnected by the removal of a cable, the failure of the existing network, etc. A known protocol (Mobile IP) provides a mechanism for allowing a network connection to be maintained and for subsequent communications from the mobile node to be made with a mobility agent of a further network. In the terms of the MobileIP protocol, the existing network is referred to as a home network and the further network is referred to as a foreign network.

In the simplest form of MobileIP, when the mobile node is connected to the foreign network, data is sent from the mobility agent of the foreign network (foreign agent) such that the return address is that of the mobility agent in the home network (home agent). Any data sent to the mobile node is first sent to the home agent, which adds further address information and forwards the data to the foreign agent in the foreign network so that it can be delivered to the mobile node. This arrangement is often referred to as tunnelling and may be thought of as the data taking a triangular route.

In a more complex arrangement reverse tunnelling is used wherein data sent by the mobile node is sent to the foreign agent which forwards the data on to the home agent for onward forwarding to the destination. The route for sending data packets to the mobile node is the same as discussed above. The process of sending data from the mobile node to the home agent before onward transmission is referred to as reverse tunnelling and is necessary if the return address for data is to be the same as the origin of the data. Modern routers often incorporate ingres and outgress filtering which only allows data through if this criteria is met.

The triangular routes may be overly complex in some circumstances and may lead to data routes which could be simplified.

### SUMMARY OF THE INVENTION

According to a first aspect of the invention there is provided a method of establishing a network connection, capable of transmitting data, from a computing device, having a network connection with an existing network, to a network, said method comprising:
1: determining whether data requested by the computing device originates within said network;
2: if said data requested by the computing device does originate within said network breaking at least a portion of said network connection with said existing network for said data and establishing a network connection with said network for that portion of the network connection that was previously connected to the existing network.

Such a method is convenient because it removes the need for triangular routing of the data as discussed above. The removal of such triangular routing should result in more efficient data paths, which may in turn increase the performance of the network connection: i.e. by reducing latency, reducing the bandwidth required to provide the network connection, etc. This method is particularly applicable to IP version 4, but may be used for other protocols.

The term network connection may in some embodiments mean that the computing device is given an address within, and/or associated with, the network. This address may be an IP address.

The computing device is conveniently referred to as a mobile node in the terms of MobileIP. Likewise, the existing wireless network is conveniently called a home network, and the wireless network is conveniently called a foreign network.

It will be appreciated that when the computing device is connected to the existing network it will be assigned an address within that network. In terms of MobileIP, a mobile node is assigned a home address within the home network (which may be the existing network), and which is within the mobile node's home link. Standard network routing mechanisms (which may be IP routing mechanisms) deliver data destined for a mobile node's home address to its home link.

The home link is a link to a specified network (which is taken to be the home network). The specified network is defined by a portion of the network address. In terms of MobileIP, the home subnet prefix is the portion of the network address that defines the home network. Therefore, and again in terms of MobileIP, the foreign network is defined as any network that is not accessed by an address having the home subnet prefix.

The existing network may be specified by a predetermined portion of an address. The network may be any network having an address that does not contain the predetermined portion specifying the existing network. Indeed, the network may be specified by a second predetermined portion of an address. If IP is being used then the existing network may be defined by a first subnet prefix, and the network may be any network that does not contain the first subnet prefix, but which may be defined by its own second subnet prefix. If another network protocol is used the network may be defined by a mechanism in that network protocol which is equivalent to, or substantially equivalent to, the subnet prefix used in IP.

It will be appreciated that data sent across a network will generally be packetised.

The method may use the Session Initiation Protocol (SIP) to initiate the breaking of said network connection to said existing network. The skilled person will appreciate that the SIP is a signalling protocol in the application layer of the seven layer network model, and may be used to send messages that facilitate the breaking of the network connection to said existing network.

Further, either of said existing and network connections may comprise a plurality of sub-connections. It is well known for a network connection to a computing device to contain data generated by a plurality of processes, perhaps separate applications running on that computing device, across the network connection. The method may break one or more of said sub-connections and allow other sub-connections to be maintained with said existing network.

According to a second aspect of the invention there is provided a computing device capable of establishing a network connection and capable of transmitting data, with an existing network, said device capable of being given a care of address by a network in order to maintain communication with said existing network such that data sent from said device uses said care of address, said device being arranged to communicate with said network without using said care of address if it is determined that data being sent to the device originates within the network.

An advantage of such a computing device, often referred to as a mobile node in terms of the MobileIP, is that it may allow for more efficient routing of the data to the computing device. As such more efficient routing provides a number of advantages to a user: may be quicker data transfer; may be more reliable data transfer (if the network connection is shorter it is less likely to fail); may be a greater bandwidth.

According to a third aspect of the invention there is provided a processing device arranged to control a network, said processing device being arranged to allow one or more computing devices to make a network connection to said network, capable of transmitting data, whilst, at least initially, maintaining a network connection to an existing network, said processing device being arranged to provide said computing device with a care of address allowing data to be routed from said existing network to said network, said computing device comprising a data transfer controller arranged to determine whether data being transmitted to said computing device originates within said network and if this is the case being further arranged to consider whether said data should transmitted without the use of said care of address.

According to a fourth aspect of the invention there is provided a network capable of allowing a computing device to establish a network connection therewith whilst maintaining a network connection to an existing network, by, initially at least, using a care of address for that computing device within the network, a data transfer controller of a processing device of the network being arranged to determine whether data being transmitted to said computing device originates within said network and if this is the case being further arranged to consider whether said data should transmitted without the use of said care of address.

According to a fifth aspect of the device there is provided a computer readable medium containing instructions which when read on to at least one processing device cause that processing device to perform the method of the first aspect of the invention.

According to a sixth aspect of the invention there is provided a computer readable medium containing instructions which when read on to a processing device cause that processing device to function according to the second aspect of the invention.

According to a seventh aspect of the invention there is provided a computer readable medium containing instructions which when read on to a processing device cause that processing device to function according to the third aspect of the invention.

According to a eighth aspect of the invention there is provided a computer readable medium containing instructions which when read on to a processing device running a network cause the network to function according to the fourth aspect of the invention.

The computer readable medium of any of the fifth, sixth, seventh, or eighth aspects of the invention may be any one or more of the following: a floppy disk; a CDROM/RAM; a DVD ROM/RAM (including +RW,−RW); any form of magneto optical disk; a hard drive; a transmitted signal (including an internet download, file transfer, or the like); a wire; or any other form of medium.

### BRIEF DESCRIPTION OF THE DRAWINGS

An embodiment of the present invention is now described by way of example only and with reference to the following drawings of which:

FIG. 1 (Prior Art) shows the tunnelling processes used by MobileIP;

FIG. 2 (Prior Art) shows the reverse tunnelling process of an enhancement of the original MobileIP;

FIG. 3 schematically shows a server for use in with present invention;

FIG. 4 schematically shows a mobile processing device for use with the present invention;

FIG. 5 shows an example arrangement of networks;

FIG. 6 shows a flowchart outlining various data accessing processes according to a first embodiment of the present invention;

FIG. 7 shows a flowchart outlining the conditions that should be met for changing an IP address of a processing device according to the second embodiment of the present invention; and

FIG. 8 shows a Figure similar to FIGS. 1 and 2 but with an arrangement according to the present invention.

### DETAILED DESCRIPTION OF THE DRAWINGS

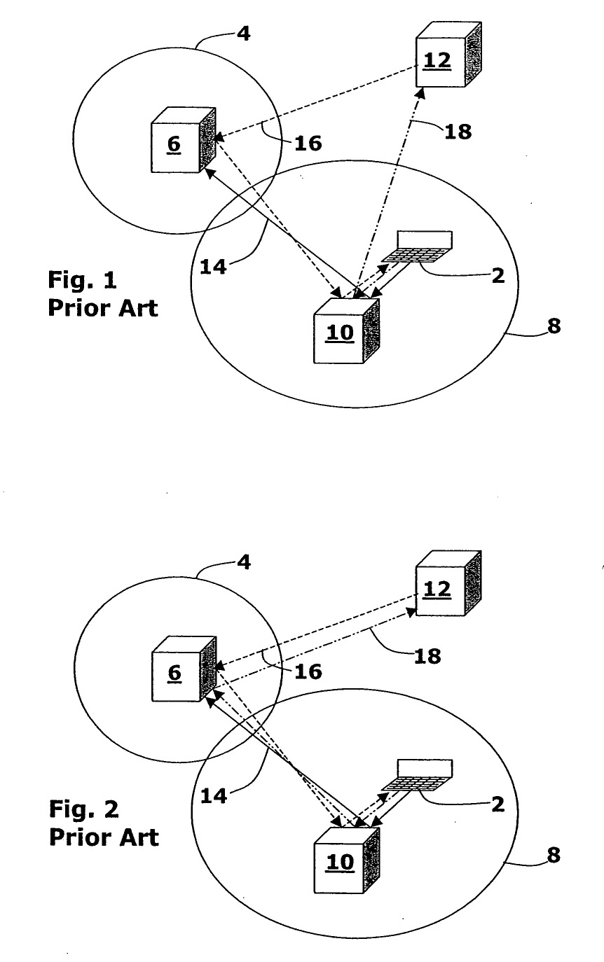

FIG. 1 shows a processing device 2 (a mobile node in the terms of the MobileIP). The mobile node 2 primarily operates within an existing wireless network 4 (home network) which is generated by a wireless hub 6, which may be provided as part of a server (home agent). However, as represented in FIG. 1 the mobile node 2 has left the home network 4 and is operating within a wireless network (foreign network) 8. The network is generated by a wireless hub 10, which may be provided as part of a server (foreign agent). A server remote from both the foreign 8 and home 4 is represented at 12.

The mobile node 2 has a home address within the home network 4 and has been assigned a care of address by the foreign agent 10. When the mobile node is assigned the care of address it notifies the home agent 6 of this care of address via a communication 14. Any inbound communications 16 intended for the mobile node 2 are and originating from, for example, the remote server 12 are sent to the home address and are therefore received by the home agent 6. The home agent 6 adds the care of address to the communication and forwards it on to the foreign agent 10 which strips the care of address and forwards the communication onto the mobile node 2.

Outbound communications intended, for example, the remote server 12 are sent by the mobile node 2 to the foreign agent 10, which forwards the communication directly to the remote server 12. Thus, it can be seen that a triangular route is formed by the inbound 16 and outbound 18 communications to the foreign network 8.

In a further example as shown in FIG. 2 the path for communications is further complicated since outbound communications 18 are sent via the home agent 6. This routing through the home agent 6 is desirable to ensure that the return and origin addresses for the communication are the same, which is necessary to pass through some types of fire wall.

FIG. 1 schematically shows the architecture of a server 100. A processor 101, is connected, via a bus 102, to a memory 104, and a hard drive 106. The bus 102 also connects the processor to a display driver 108, which can drive a monitor connected to an output interface 110. An input/output controller 112, also connects to the bus 102 and allows a keyboard, mouse, etc. to be connected the processor 101 via ports 114. A network controller 116 is provided to connect the processor 101 to a network via an output port 118. The processor 101 is further connected to an IP port 120, which provides access to the Internet. The server 100, together with network adapters, provides the necessary processing circuitry to operate a network.

FIG. 2 shows an example of a processing device that could be connected to a network. In the example shown, the computing device 2 is a portable PC running the LINUX operating system. However, in other embodiments the portable PC may be any other form of computing device, and may be portable PC's running Microsoft™ Windows™ 2000, Apple™ iBooks™, PDA's, telephones, or any other form of computing device. Such a computing device may be suitable for providing the mobile nodes discussed herein.

The structure of the computing device 2 is similar to that of the server. A processor 201 is connected, via a bus 202, to a memory 204, and a hard drive 206. The bus 202 also connects the processor to a display driver 208, which drives a display mounted on the computing device. An input/output controller 212, is also connected to the bus 202 and drives a keyboard 220 and a trackpad 222 via a connection 214 and allow a user to make inputs thereto. A network card, in this case wireless network PCMIA card 216, is provided to allow the processor 201 to make a network connection to a network via an aerial 218 which in this case is external to the computing device 2.

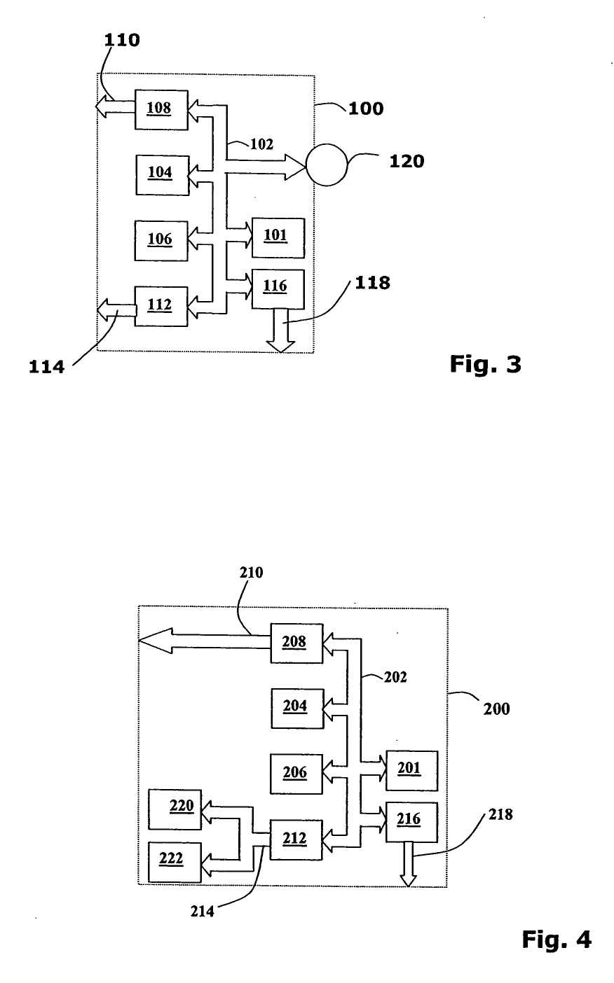

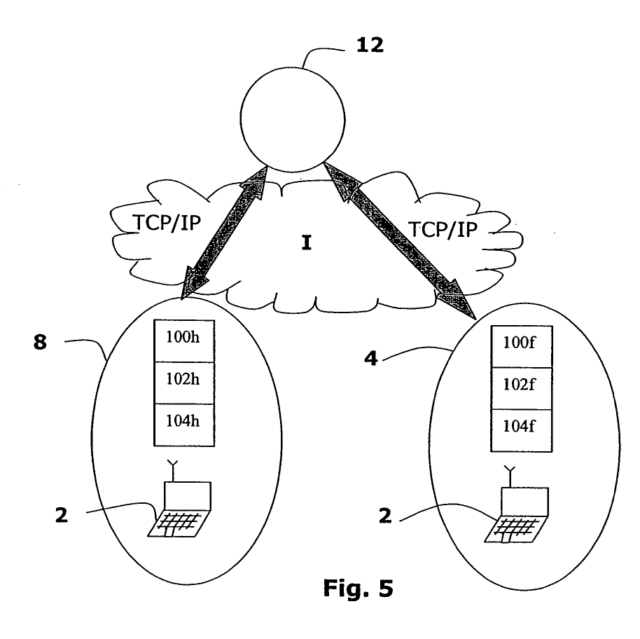

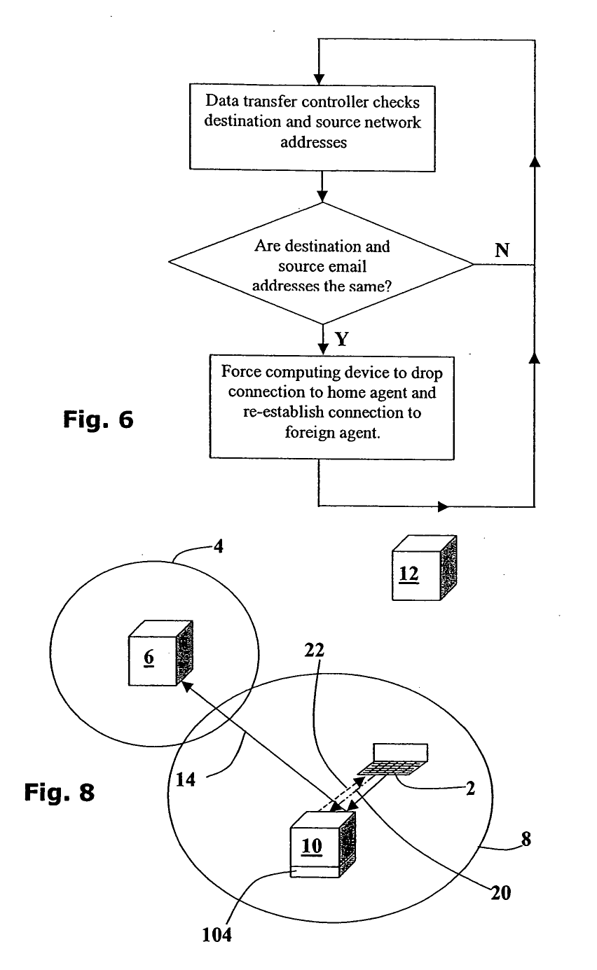

The present invention will be described in relation to mobile computing devices, or mobile nodes 2 which move between wireless networks. It will be appreciated that in its broadest aspects the invention could be applied to wired networks, and a combination of wired and wireless networks. An example arrangement for two such networks is shown in FIG. 3. FIG. 3 shows two wireless networks 4, 8 each controlled by a server 100h, 100f. Each server 100h, 100f has the features of the server 100 shown in FIG. 1, and like parts are labelled with like numbers with a suffix designating the particular server. Each server is connects to a router 102f,102h which generates the surrounding wireless network and may be referred to as a mobility agent. The mobility agent may function as either a home or foreign agent.

In this embodiment, the wireless networks—a home network 4 and a foreign network FH—both utilise WIFI (or IEEE 802.11) protocol. The skilled person will fully understand this protocol, but they are directed to read the IEEE standard 802.11 for further information. The skilled person will appreciate that there are a plurality of different IEEE 802.11 standards, each of which may be applicable to this invention. Further there are other wireless network standards as will be explained hereinafter which may also be applicable. FIG. 3 further shows a remote data source, in this case provided by a server 12, and a representation of the Internet I. Using known TCP/IP protocols, it is possible for each of the servers 100h, 100f to communicate with each other and with the server 12 over the Internet using the IP ports 120h, 120f of the servers 100h, 100f. Of course, other transport protocols are known and equally applicable to this invention.

The home network 4 is the network with which the device is most usually required to communicate. The home network 4 may be for example a company ‘Intranet’, which may be thought of as a shared resource available to the user of the computing device 2 and is operated by a server 100h. The computing device 2 can communicate with the home network, for example, within the offices of the company in which the network is provided, via its aerial 218 using known WIFI protocols. When connected to home network 4, the computing device 2 will have an IP address assigned by the server 100h which uniquely identifies it to the server 100h.

However, it will be appreciated that the computing device 2 may move beyond the physical area covered by the home network 4 and into an area covered by the foreign network 8. According to existing WIFI protocols, the computing device 2 may connect to the server 100f of the foreign network 8.

The skilled person will appreciate that such a network connection may be possible even if the home network 4 and the foreign network 8 utilise different protocols and such connection utilises the processes described in relation to FIGS. 1 and/or 2. For example, the home network 4 may be a GPRS network with which the computing device is communicating and the foreign network 8 may be a hotspot network such as a WIFI network.

In this embodiment the server 100f of the foreign network 8 is provided with a data transfer controller 104 (or data transfer controller means), which may be a software application running on the processor 101f. The data transfer controller means may also be provided by hardware such as an integrated circuit, or as firmware within a device. The data transfer controller 104 is arranged to perform a comparison between the network address that originated a request for data and the network address of the requested data, and to initiate data transfer procedures dependant on the result of that comparison as described herein.

In possibly the simplest embodiment of the present invention if the data transfer controller 104 determines that the network address from which the computing device 2 is requesting data is the same network to which the computing device is currently connected then the data transfer controller 104 forces the computing device to drop its network connection to the home network. At roughly the same time as the network connection to the home network is broken, then a network connection is made to the foreign network so that it appears to the user that there has always been a network connection present; this network connection to the foreign network is made without the use of the care of address as was previously the case.

The data transfer controller 104 may be provided by a SIP (Session Initiation Protocol) server. The SIP server may be arranged to send a signal to the computing device 2 that the use of the care of address is about to be terminated for one or more of the network connections and/or sub connections. The signal may incorporate a new IP address for the computing device to use whilst it is within the foreign network 8 for the portions of the connection for which the care of address is no longer being used.

For example a user of a mobile computing device may move into a foreign network 8, whilst being connected to a home network 4, and wish to establish a video link involving data on the foreign network 8. Using the prior art MobileIP the data for such a video link is sent (using a care of address that has been assigned to the computing device 2) to the home agent 6 and is then forwarded back to the computing device 2 via the foreign agent 10 of the foreign network 8. According to the present embodiment, the data transfer controller 104 may determine (depending on the discussions below) that such routing is inefficient and assign the computing device an IP address within the foreign network 8 for the purposes of that video link. The route for the data is thus shortened, which may improve the quality of the link. When the video link is finished the new IP address may or may not be maintained.

The network connection between the computing device 2 and the home network 4 may comprise a plurality of sub connections each of which will generally be assigned to a different application running on the computing device and/or port of the computing device. It is of course possible for a plurality of sub channels and/or ports to be assigned to a single application. In some embodiments of the invention, the data transfer controller 104 may monitor each of the sub connections and transfer one or more sub connections to the foreign network should it be determined that the data being requested on that sub-connection originates on the foreign network.

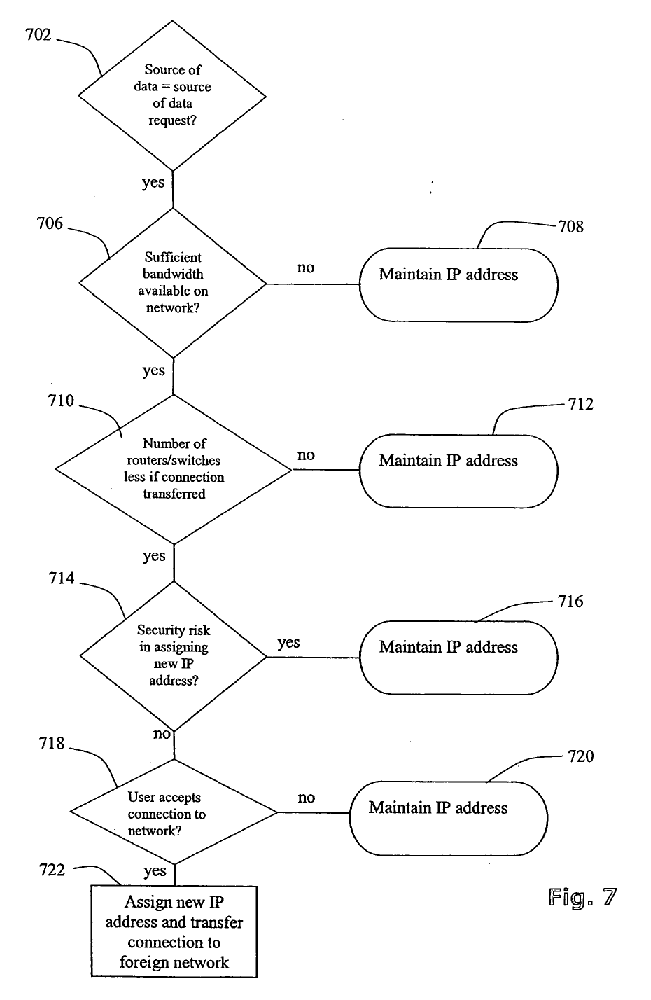

There may be other parameters that the data transfer controller 104 considers before the network connection and/or sub connection is transferred to the foreign network and these are shown in the flow chart of FIG. 7. For example, there may not be enough bandwidth available on the foreign network to support a further network connection, or there may not be enough bandwidth to support another network connection without degrading the quality of service of existing network connections. Therefore, the data transfer controller 104 may assess the network loading 706 and determine whether further network connections can be made to the foreign network. It will be appreciated that the loading on the foreign network 8 will be higher if a network connection is made to that network rather than it simply forwarding data on to and/or from the home network 4. Therefore, the loading will increase on the foreign network 8 if the network connection from the computing device 2 to the home network 4 is terminated and re-established with the foreign network 8.

Another parameter that the data transfer controller 104 may take into consideration before breaking the network connection 16,18 to the home network 4 and transferring it to the foreign network 8 is the number of routers/switches and the like 710 that data must pass through within the foreign network 8 before data reaches the computing device 2. For example, if the foreign network is complex then the data may have to pass through several routers/switches/or the like before it is sent to the computing device 2, whereas the network connection between the home 4 and foreign 8 networks may involve less routers/switches/or the like. Since the home 4/foreign 8 network connection has fewer routers/switches/or the like then it is likely to be convenient to leave the, or each, network connection/sub connection 16,18 to the home network 4 in place.

The data transfer controller 104 may also be arranged to consider 714 the security implications of transferring the, or each, network connection and/or sub connection 16,18 to the foreign network 8. It may be determined that it would be an unacceptable security risk to have the extra network connection directly on the foreign network 8 and as such the or each network connection and or sub connection 16,18 may be maintained to the home network 4.

Further, the data transfer controller 104 may be arranged 718 to give a user of the computing device 2 the option as to whether he/she wishes to have the or each network connection and/or sub-connection transferred to the foreign network 8.

If the data transfer controller 104 determines that for any of the reasons discussed above that the or each network connection and/or sub connection 16,18 should be maintained 708,712,716,720 to the home network 4 then the care of address is maintained and data to the computing device 2 continues to be routed via the home agent 6. Further, if reverse tunnelling is being used, as described in relation to FIG. 2, data from the computing device 2 continues to be routed via the home agent 6.

FIG. 8 shows a network in which the data transfer controller 104 has determined that the or each network connection and/or sub connection 16,18 should be moved from the home 4 to the foreign 8 network. New network connections 20,22 are shown from the computing device 2 to the foreign agent 10. It will be appreciated that because, in this embodiment, the link to the home agent 6 is only dropped if the data being requested from within the foreign network the new network connections 20,22 do not extend outside the foreign network 8. If data is required from outside the foreign network 8 then the routing through the home agent 6 is maintained and/or re-established.

The computing device 2 may or may not continue to inform the home agent 6 of the network in which it is located via communications 14 by informing the home agent 6 of the care of address. It will be appreciated that if only some of the network connections and/or data sub-connections that exist between the computing device 2 and the home network 4 are transferred to the foreign network 8 then the home agent 6 will still need to forward data onto the computing device 2 for the remaining data network connections and/or sub-connections and will therefore need an up to date care of address.

Further, once data which originates within the foreign network is no longer being requested then it may become inappropriate to use the IP address assigned to the computing device within the foreign network. In such circumstances, the computing device may re-establish a connection to the home network using the care of address previously assigned to the computing device.

1. A method of establishing a network connection capable of transmitting data from a computing device to a network wherein the computing device is capable of connecting to at least one network and of making requests for data from the at least one network and has a network connection with an existing network, the method comprising:
i: determining whether data requested by the computing device originates within the network;
ii: if the data requested by the computing device does originate within the network, breaking at least a portion of the network connection with the existing network and establishing a network connection with the network for that portion of the network connection that was previously connected to the existing network.

2. A method according to claim 1 which uses the Session Initiation Protocol (SIP) to initiate the breaking of the network connection to the existing network.

3. A method according to claim 1 in which at least one of the network and existing network comprises a plurality of sub connections and the method is applied to at least one of the sub connections.

4. A method according to claim 1 in which the portion of the network connection with the existing network that is broken is re-established once data no longer originates within the network.

5. A method according to claim 1 in which MobileIP is used to maintain a network connection with the existing network.

6. A method according to claim 1 in which the computing device is assigned an IP address within the network for transmission of data that originates from the network.

7. A method according to claim 6 in which MobileIP is used to maintain a network connection with the existing network and the IP address assigned to the computing device is used instead of a care of address assigned by the MobileIP for data that originates within the network.

8. A method according to claim 1 in which the computing device is capable of assessing security implications, bandwidth and speed of a proposed connection and before at least a portion of the network connection with the existing network for the data is broken and a network connection with the network for that portion of the network connection that was previously connected to the existing network is established, an assessment of at least one of the following is made: the security implications for the network; whether there is sufficient bandwidth in the network to support the new connection; whether a network connection to the network would be faster/slower than the network connection to the existing network.

9. A computing device capable of establishing a network connection with, and capable of transmitting data to, an existing network, the device capable of determining the origin of data transmissions and further being capable of being given a care of address by a network which can be used to enable data transmission to the existing network such that data sent from the device generally uses the care of address, the device being arranged to communicate with the network without using the care of address if it is determined that data being sent to the device originates within the network.

10. A device according to claim 9 which is arranged to receive a network address, which may be an IP address, to use whilst performing one of requesting and receiving data originating from within the network.

11. A device according to claim 10 which is arranged such that, once data no longer originates from within the network, the network address is no longer used.

12. A processing device capable of controlling a network and network connections within a network, the processing device being capable of allowing at least one computing device to make a network connection to the network, which connection is capable of transmitting data, whilst, at least initially, maintaining a network connection to an existing network, the processing device being arranged to provide the at least one computing device with a care of address allowing data to be routed from the existing network to the network, the at least one computing device comprising a data transfer controller capable of determining whether data being transmitted to the computing device originates within the network and if this is the case being further capable of considering whether the data should transmitted without the use of the care of address.

13. A processing device according to claim 12 which is arranged to assign a network address, which may be an IP address, to a computing device once it has been determined that the care of address should not be used.

14. A processing device according to claim 12 which is capable of assessing at least one of the following parameters before determining that a care of address should not be used: the security implications for the network; whether there is sufficient bandwidth in the network to support the new connection; whether a network connection to the network would be faster/slower than the network connection to the existing network.

15. A network capable of allowing a computing device to establish a network connection therewith whilst maintaining a network connection to an existing network, by, initially at least, using a care of address for that computing device within the network, a data transfer controller of a processing device of the network being arranged to determine whether data being transmitted to said computing device originates within said network and if this is the case being further arranged to consider whether said data should be transmitted without the use of said care of address.

16. A memory storing instructions which when read on to at least one processing device cause that processing device to perform the method of claim 1.

17. A memory storing instructions which when read on to a processing device cause that processing device to function as the device of claim 9.

18. A memory storing instructions which when read on to a processing device cause that processing device to function as the device of claim 12.

19. A memory storing instructions which when read on to a processing device running a network cause the network to function as the network of claim 15.

20. A method of establishing a network connection to a network, the network connection being capable of transmitting data from a computing device, the computing device having assigned thereto a network address from an existing network and having a network connection with the existing network, the method comprising:
i: providing the computing device with a care of address as it enters the network so that data intended for the computing device can be routed to the computing device whilst it is in the network;
ii: determining whether data requested by the computing device originates within the network;
iii: if the data requested by the computing device does originate within the network, breaking at least a portion of the network connection with the existing network and assigning a network address for the network to the computing device such that the data is sent to the computing device from the network rather than using the care of address for that portion of the network address that has had its connection to the existing network broken.

21. A device capable of establishing a network connection with and capable of transmitting to, a home network, the device capable of determining the origin of data transmissions and further being capable of being given a care of address by a foreign network which can be used to enable data transmission to the home network such that data sent from the device generally uses the care of address, the device being arranged to communicate with the foreign network without using the care of address if it is determined that data being sent to the device originates within the foreign network.

22. A server capable of controlling a network and network connections within a network, the server being capable of allowing at least one computing arrangement capable of connecting to a network to make a network connection to the network, the connection being capable of transmitting data, whilst, at least initially, maintaining a network connection to an existing network, the server being arranged to provide the at least one computing arrangement with a care of address allowing data to be routed from the existing network to the network, the at least one computing arrangement comprising a data transferrer capable of determining whether data being transmitted to the computing arrangement originates within the network and if this is the case being further capable of considering whether the data should transmitted without the use of the care of address.

23. A network capable of allowing a computing arrangement capable of establishing a connection with a network to establish a network connection therewith whilst maintaining a network connection to an existing network, by, initially at least, using a care of address for that computing arrangement within the network, the network comprising a processing arrangement which further comprises a data transfer controller for determining whether data being transmitted to the computing arrangement originates within the network and, if this is the case, being arranged to considering whether the data should transmitted without the use of the care of address.

24. A method of establishing a network connection capable of transmitting data from a computing device to a network wherein the computing device is capable of connecting to at least one foreign network and of making requests for data from the at least one foreign network and has a network connection with a home network, the method comprising:
i: determining whether data requested by the computing device originates within the foreign network;
ii: if the data requested by the computing device does originate within the foreign network, breaking at least a portion of the network connection with the home network and establishing a network connection with the foreign network for that portion of the network connection that was previously connected to the home network by assigning an IP address to the computing device within the foreign network for transmission of data that originates from the foreign network; and
iii. using MobileIP to maintain a network connection with the home network and the IP address assigned to the computing device is used to send data to the computing device instead of a care of address assigned by the MobileIP for data that originates within the foreign network.

25. A method according to claim 24 in which at least one of the foreign network and home network comprises a plurality of channels and the method is applied to at least one of the channels.

26. A method according to claim 24 which uses the Session Initiation Protocol (SIP) to initiate the breaking of the network connection to the home network.

27. A computing device capable of establishing a network connection with, and capable of transmitting data to, an existing network, the device being capable of determining the origin of data transmissions and further being capable of receiving a care of address from a network which can be used to enable data transmission to the existing network such that data sent from the device generally uses the care of address, if it is determined that data being sent to the device originates within the network then the device is arranged to receive a network address to use whilst performing one of requesting and receiving data originating from within the network and thereafter the device being arranged to communicate with the network without using the network address until such time that data no longer originates from within the network after which the network address is no longer used.

28. A computing device according to claim 27 in which the network address is an IP address.
